(19) United States
(12) Patent Application Publication
(10) Pub. No.: US 2004/0212115 A1
(43) Pub. Date: Oct. 28, 2004

(54) Waveform monitoring apparatus and method for monitoring waveform

(75) Inventors: Yoshiyuki Akiyama, Shizuoka (JP); Toshimi Nakashima, Shizuoka (JP); Yoshiaki Matsumoto, Shizuoka (JP); Tadayuki Yamada, Shizuoka (JP); Hisayoshi Tanahashi, Shizuoka (JP)

Correspondence Address: Finnegan, Henderson, Farabow,, Garrett & Dunner, L.L.P., 1300 I Street, N.W., Washington, DC, 20005-3315, US

(73) Assignee: Yazaki Corporation

(21) Appl. No.: 10/757,413

(22) Filed: Jan. 15, 2004

(30) Foreign Application Priority Data
Jan. 16, 2003 (JP) P. 2003-008328

(51) Int. Cl. B29C 45/76

(52) U.S. Cl. 264/40.1; 425/169; 264/40.5

(57) ABSTRACT

A waveform monitoring apparatus includes a hydraulic cylinder which is incorporated in an injection molding device and ejects a molding material, a sensor which generates pressure data of the hydraulic cylinder, a determinant which forms a measured value waveform based on the pressure data and determines whether the pressure data exceeds a reference pressure waveform by a predetermined range, a marking applier which applies a marking to an excess portion of the measured value waveform determined by the determinant.

### BACKGROUND OF THE INVENTION

The present invention relates to a waveform monitoring apparatus which is combined with an injection molding device to determine the conformity/nonconformity of a molded product based on the pressure data of a hydraulic cylinder and a method for monitoring a wave form.

In a related waveform monitoring apparatus which is combined with an injection molding device to determine the conformity/nonconformity of a molded product, process data during injection molding, such as injection speed, injection pressure and screw position varies in accordance with set values in a single-shot process of forming molded products and can be drawn as a single analog waveform in a single-shot process per data item. The analog waveform is not subject to great variations unless an abnormality takes place.

Thus, conformity/nonconformity is determined by providing an analog waveform corresponding to a conforming product with an allowance range between upper limit and lower limit to set an analog upper limit waveform and an analog lower limit waveform and monitoring whether a real waveform per shot falls within the allowance range of the preset analog upper limit waveform and analog lower limit waveform.

Such related wave monitoring apparatus, as shown in FIG. 4A, generates an analog upper limit waveform UW1 in which a first value (α) as a first allowance is added to an analog standard waveform SW1 and an analog lower limit waveform LW1 in which a second value (β) as a second allowance is subtracted from the analog standard waveform SW1, where α may be equal to β. The range between the analog upper limit waveform UW1 and the analog lower limit waveform LW1 is a conformity/nonconformity determination area where a conforming product is obtained.

A data process section determines whether an analog real waveform transferred per shot from a signal processor falls within the range. When detecting any exceeding portion of the analog real waveform, the data process section assumes nonconformity, and communicates the nonconformity to a controller through the signal processor and a signal line as well as to a upper level computer through a communications processor.

As shown in FIG. 4B, the related wave monitoring apparatus sets an analog upper limit waveform and an analog lower limit waveform by way of multiplication as well as addition of α and subtraction of β. For an upper limit, the wave monitoring apparatus sets an analog upper limit waveform UW1′ by multiplying a value of the analog standard waveform SW1 by (1+x) and an analog lower limit waveform LW1′ by multiplying a value of the analog standard waveform SW1 by (1−y), where x and y are positive coefficients (refer to for example JP-A-7-205244, pages 3-4, FIG. 2).

However, on the related waveform monitoring apparatus described in JP-A-7-205244, a reference waveform is not shown when nonconformity is determined so that a nonconforming section and the degree of nonconformity as well as the difference and variation from a conformity case are not clear.

### SUMMARY OF THE INVENTION

It is therefore an object of the present invention to provide a waveform monitoring apparatus and a method for monitoring a waveform which eliminate the need for a visual check after forming of molded products and proactively prevents outflow of nonconforming products by determining nonconforming products before molded products are formed by way of a marking on a measured value waveform as well as enhances the productivity by detecting during the molding process any problem in a molding machine, an auxiliary facility and molding conditions.

In order to achieve the above object, according to the present invention, there is provided a waveform monitoring apparatus, comprising:

a hydraulic cylinder, incorporated in an injection molding device for ejecting a molding material;

a sensor, generating pressure data of the hydraulic cylinder;

a determinant, forming a measured value waveform based on the pressure data, and determining that whether the pressure data exceeds a reference pressure waveform by a predetermined range; and

a marking applier, applying a marking to an excess portion of the measured value waveform determined by the determinant.

The waveform monitoring apparatus comprises a display which displays the measured value waveform having the excess portion to which the marking is applied.

In the above configuration, a displayed measured value waveform is given a marking when the pressure data of the hydraulic cylinder has exceeded the reference pressure waveform by the predetermined range so that conformity/nonconformity will be determined based on the current pressure data of the hydraulic cylinder in the process of molding before the injection molding device completes forming of molded products.

This configuration eliminates the need for performing a visual check after the molded products are formed thus proactively preventing outflow of nonconforming products. Any problem in a molding machine, an auxiliary facility and molding conditions is detected during the molding process so that the corresponding feedback is made in a short time thereby enhancing the productivity.

Preferably, the waveform monitoring apparatus further comprises a sorter which sorts a product formed from the molding material. The determinant outputs a determination signal indicating whether the pressure data exceeds the reference pressure waveform by the predetermined range to the sorter.

In the above configuration, for example, transfer of the determination signal to the sorter is stopped when the pressure data has exceeded the reference pressure waveform by a predetermined range.

Thus, the sorter stops receiving the determination signal in the molding process before the injection molding device completes forming of molded products. Nonconforming products are determined before molded products are transported, which allows production without waste of time.

Preferably, the determinant stops an injecting operation of the injection molding device when the measured value waveform in which the pressure data exceeds a reference pressure waveform by a predetermined range is continuously detected more than a predetermined times.

In the above configuration, when shots in which pressure data has exceeded the reference pressure waveform by a predetermined range have successively occurred in excess of a predetermined count, the injection molding device is shut down.

This minimizes the occurrence of nonconforming products so that it is possible to considerably reduce the waste of materials.

Preferably, the determinant sets a upper limit range and a lower limit range with respect to the reference pressure waveform as the predetermined range.

In the above configuration, the determinant uses the upper and lower predetermined ranges of the reference pressure waveform to make conformity/nonconformity determination.

It is thus possible to monitor secular change in the hydraulic cylinder and hydraulic supply equipment around the hydraulic cylinder simultaneously with determination of conforming/nonconforming products. This assures overall monitoring of an injection molding device.

Preferably, the waveform monitoring apparatus further comprises a storage which stores the measured value waveform to which the marking is applied.

In the above configuration, a measured value waveform with a marking is stored in the storage.

It is thus possible to output the measured value waveform stored for example on a printer and use the output of the measured value waveform for feedback to manage problems in the molding device, an auxiliary facility and molding conditions based on the error occurrence time and a deviation in the pressure data. The operator need not constantly watch the monitor screen so that the load on the operator is reduced.

According to the present invention, there is also provided a method for monitoring a waveform, comprising the steps of:

generating pressure data of a hydraulic cylinder incorporated in an injection molding device for ejecting a molding material;

forming a measured value waveform based on the pressure data;

determining that whether the pressure data exceeds a reference pressure waveform by a predetermined range; and

applying a marking to an excess portion of the measured value waveform determined in the determinant step.

Preferably, the method further comprises the step of displaying the measured value waveform having the excess portion to which the marking is applied.

Preferably, the method further comprises the step of outputting a determination signal to a sorter which sorts a product formed from the molding material. The determination signal indicates that whether the pressure data exceeds the reference pressure waveform by the predetermined range.

Preferably, the method further comprises the step of stopping an injecting operation of the injection molding device when the measured value waveform in which the pressure data exceeds a reference pressure waveform by a predetermined range is continuously detected more than a predetermined times.

Preferably, the predetermined range is set a upper range and a lower range with respect to the reference pressure waveform.

Preferably, the method further comprises the step of storing the measured value waveform to which the marking is applied.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram of a simple waveform monitoring apparatus according to an embodiment of the invention;

FIG. 2 is a waveform diagram obtained when the upper limit value is No Good (NG) on the simple waveform monitoring apparatus shown in FIG. 1;

FIG. 3 is waveform diagram obtained when the lower limit value is NG on the simple waveform monitoring apparatus shown in FIG. 1; and

FIG. 4 is a diagram showing the waveforms on the related waveform monitoring apparatus.

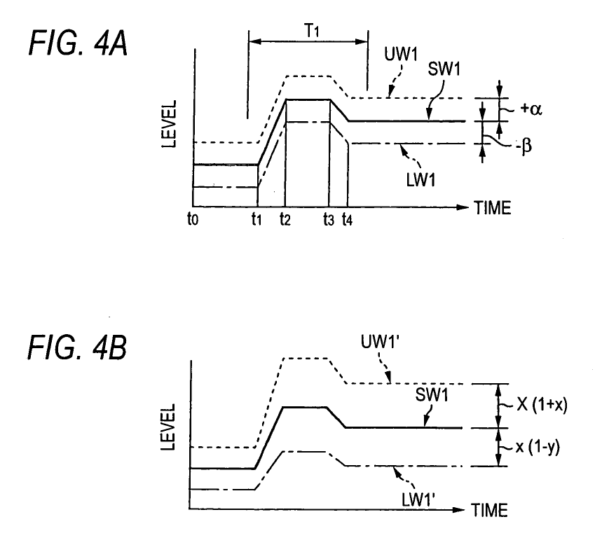

### DETAILED DESCRIPTION OF THE PREFERRED EMBODIMENTS

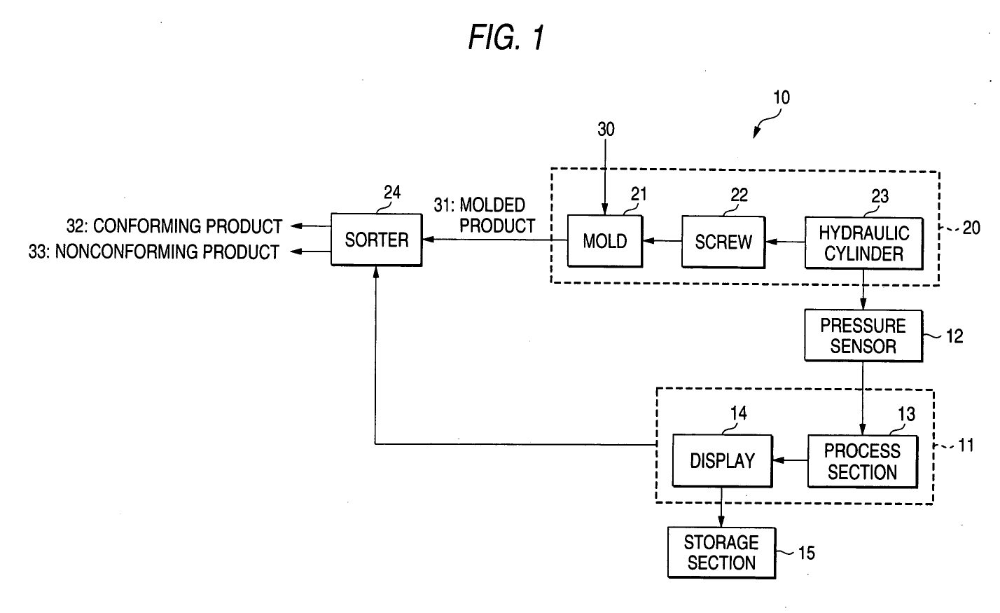

Embodiments of the simple waveform monitoring apparatus according to the invention are detailed referring to FIGS. 1 through 3.

As shown in FIG. 1, simple waveform monitoring apparatus 10 according to an embodiment of the invention is combined with an injection molding device 20 including a mold 21, a screw 33 and a hydraulic cylinder 23, and a sorter 24. The simple waveform monitoring apparatus 10 basically includes a pressure sensor 12, a determination unit 11 incorporating a process section 13 and a display 14, and a storage section 15.

In injection molding, the injection molding device 20 is pushed toward a screw head (not shown) and a ring valve (not shown) via the rotation of a screw 22 engaged with the screw head after a material (molding material) 30 is charged in a hydraulic cylinder (heating cylinder) 23.

Next, the material 30 is pushed by a predetermined volume onto the tip of the hydraulic cylinder 23 via a gap between the screw head and the ring valve so that measurement of the material is made. After measurement, the screw 22 is advanced and the material 30 is injected into the cavity of the mold 21 for perform injection molding.

The pressure sensor 12 is a contact-type sensor mounted on the hydraulic cylinder 23 for checking the hydraulic pressure in the hydraulic cylinder 23. The pressure data detected by the hydraulic cylinder 23 is converted to an electric signal via an amplifier and an analog/digital converter circuit, and transferred to the process section 13 of the determination unit 11. Typically, the pressure in the hydraulic cylinder 23 rises to peak around 0.5 seconds then drops to a predetermined value.

The process section 13 includes an arithmetic unit such as a microcomputer. The process section 13 performs arithmetic operation of an electric signal transferred from the pressure sensor 12 to calculate and register a sampling data signal for creating a sampling waveform as a reference for a single shot of molding. The process section 13 calculates and registers, per shot, an upper value data signal for creating an upper limit value waveform within an upper allowance predetermined in the X direction and a lower value data signal for creating a lower limit value waveform within a lower allowance predetermined in the Y direction.

Further, the process section 13 performs arithmetic operation of an electric signal transferred from the pressure sensor 12 to calculate and register, per shot, a measured value data signal independent of a sampling data signal for creating a measured value waveform. The process section 13 calculates whether the deviation of the value of the measured value signal from the value of the sampling data signal exceeds the value of the upper limit value data signal or is lower than the value of the lower limit value data signal. In case the value of the measured value data signal is greater than the value of the sampling data signal and exceeds the value of the upper limit value data signal (upper limit threshold), the process section 13 assumes the range of the measured value data signal in excess of the upper limit value data signal as an upper limit value NG range, and applies an upper limit value error signal to the measured value waveform so that the measured value data signal is displayed as a thick line.

In case the value of the measured value data signal is smaller than the value of the sampling data signal and is smaller than the value of the lower limit value data signal (lower limit threshold), the process section 13 assumes the range of the measured value data signal in excess of the lower limit value data signal as an lower limit value NG range, and applies an lower limit value error signal to the measured value waveform so that the measured value data signal is displayed as a thick line. The sampling data signal, the upper limit value data signal, the lower limit value data signal, the measured value data signal, the upper limit value error signal, and the lower limit value error signal are transferred to the display 14.

The display 14 is a monitor arranged in close proximity to the injection molding device 20. The display 14 performs waveform conversion of a sampling data signal transferred from the process section 13 to display a sampling waveform (reference pressure waveform) and performs waveform conversion of a measured value data signal transferred from the process section 13 to display a measured value waveform. In this practice, when an upper limit value error signal is superimposed on the measured value data signal transferred from the process section 13, the display 14 displays the measured value waveform in a thick line within the upper limit value NG range.

When a lower limit value error signal is superimposed on the measured value data signal transferred from the process section 13, the display 14 displays the measured value waveform in a thick line within the lower limit value NG range. The display 14 may display an upper limit value waveform by performing waveform conversion of an upper limit value data signal transferred from the process section 13, or may display a lower limit value waveform by performing waveform conversion of a lower limit value data signal transferred from the process section 13.

When an upper limit error signal or a lower limit error signal is superimposed on the measured value data signal transferred from the process section 13, the determination unit 11 determines nonconforming products during a molding process without transferring a signal to the sorter 24. In contrast, when an upper limit error signal or a lower limit error signal is not superimposed on the measured value data signal transferred from the process section 13, the determination unit 11 determines conforming products while transferring a conforming product by transferring the signal to the sorter 24.

When an upper limit error signal or a lower limit error signal is successively superimposed on the measured value data signal transferred from the process section 13 for five shots of molding, the determination unit 11 outputs a shutdown signal to the injection molding device 20 to shut down the injection molding device 20 urgently. The determination unit 11 may output a shutdown signal only when an upper limit error signal or a lower limit error signal appears successively. However, the determination unit 11 may output a shutdown signal also when both an upper limit error signal and a lower limit error signal appear successively.

When an upper limit value error signal or a lower limit value error signal is transferred to the storage section 15, the storage section 15 acquires the measured value data signal in which the upper limit value error signal or lower limit value error signal is superimposed, and stores the measured value data signal into a storage unit such as a predetermined RAM or a hard disk. The measured value waveform of the measured value data signal in which the upper limit value error signal or lower limit value error signal is superimposed is output for example on a printer, and used for feedback to manage problems in a molding machine, an auxiliary facility and molding conditions based on the error occurrence time and a deviation in the pressure data.

The molded product 31 formed by the injection molding device 20 is transferred to the sorter 24. When a conforming product determination signal is transferred from the determination unit 11 to the sorter 24, the sorter 24 sorts the transported molded product 31 into a conforming product bucket 32. On the other hand, when the conforming product determination signal is not transferred from the determination unit 11, the sorter 24 sorts the transported molded product 31 into a nonconforming product bucket 33.

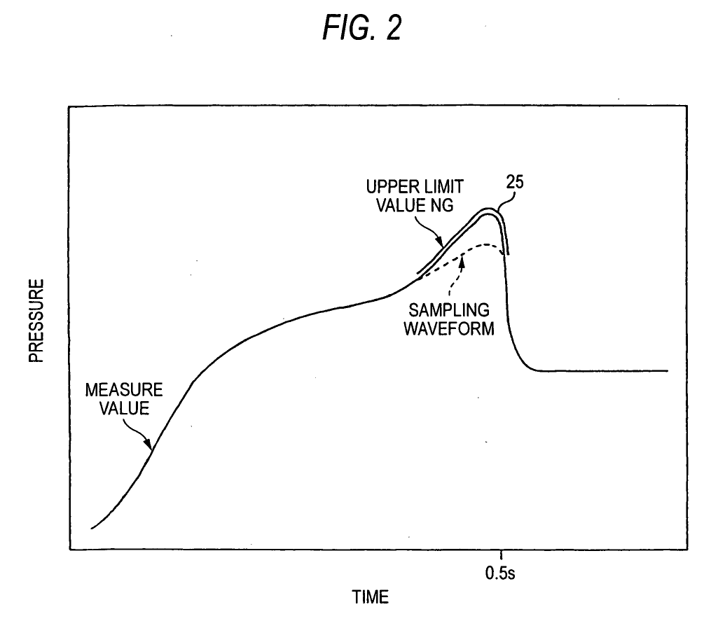

As shown in FIG. 2, the hydraulic pressure in the hydraulic cylinder 23 starts to rise about 0.5 seconds earlier and once the measured value becomes greater than the value of the sampling waveform thus exceeding the upper limit value NG range, the measured value waveform is displayed on the display 14 in a thick line with a marking 25 and the error occurrence time and pressure data are stored in the storage section 15.

At the same time, the determination unit stops transferring a conforming product determination signal so that the sorter 24 sorts the molded product 31 transported from the injection molding device 20 into the nonconforming product bucket 33.

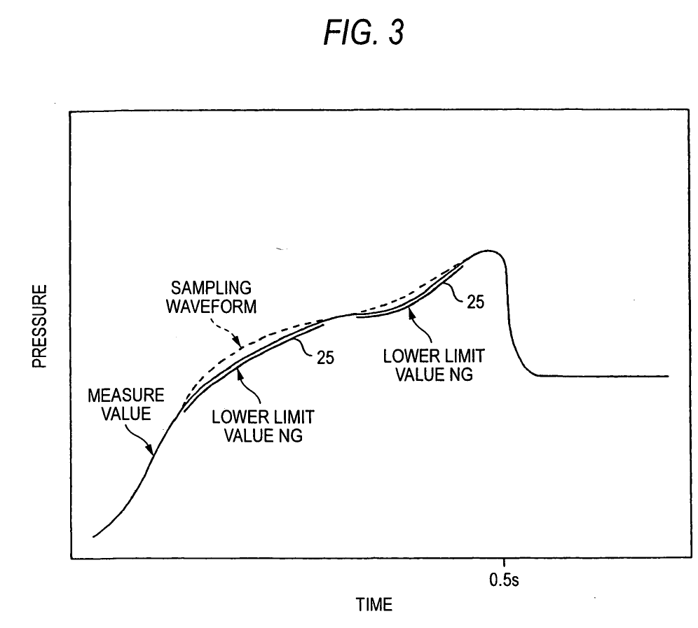

As shown in FIG. 3, the hydraulic pressure in the hydraulic cylinder 23 drops in 0.1 to 0.2 seconds and further drops in 0.3 to 0.4 seconds. Once the measured value becomes smaller than the value of the sampling waveform thus getting below the lower limit value NG range, the measured value waveform is displayed on the display 14 in a thick line with markings 25 and the error occurrence time and pressure data are stored by the storage section 15.

At the same time, the determination unit stops transferring a conforming product determination signal so that the sorter 24 sorts the molded product 31 transported from the injection molding device 20 into the nonconforming product bucket 33.

The simple waveform monitoring apparatus 10 according to the embodiment can display a measured value waveform in a thick line thus notifying in advance any nonconforming product on the display 14 so that conformity/nonconformity will be determined based on the current pressure data of the hydraulic cylinder 23 in the process of molding before the injection molding device 20 completes forming of the molded products 31. This eliminates the need for performing a visual check after the molded products are formed thus proactively preventing outflow of nonconforming products.

The sorter 24 stops receiving the conforming product determination signal in the molding process before the injection molding device 20 completes forming of the molded products 31. Nonconforming products are determined before molded products 31 are transported, which allows molding without waste of time.

When an upper limit error signal or a lower limit error signal is successively superimposed on the measured value data signal, the injection molding device 20 is brought into emergency shutdown, which eliminates the waste of materials. Any problem in a molding machine, an auxiliary facility and molding conditions is detected during the molding process so that the corresponding feedback is made in a short time.

The determination unit 11 determines conformity/nonconformity based on an upper predetermined range and a lower predetermined range of the reference pressure waveform. It is thus possible to monitor secular change in the hydraulic cylinder 23 and hydraulic supply equipment around the hydraulic cylinder simultaneously with determination of conforming/nonconforming products in the molded products 31. This assures overall monitoring of an injection molding device.

A measured value waveform given a marking 25 is stored in the storage section 15. By outputting the measured value waveform stored in the storage to a printer for example, the error occurrence time and degree of the deviation in the pressure data are clearly displayed, and the measured value waveform obtained may be used for feedback to manage problems in a molding machine, an auxiliary facility and molding conditions.

The waveform monitoring apparatus according to the invention is not limited to the foregoing embodiments but may be changed and modified as required.

For example, as an error indication, the measured value waveform may be displayed in a different color instead of a thick line, or may be given a special marking. A warning lamp may turn on or a buzzer may sound when an error takes place.

The shutdown signal from the determination unit may be output when an upper limit error signal or a lower limit error signal is successively superimposed on the measured value data signal for two or three shots of molding as a shorter elapsed time instead of five shots of molding, in order to more efficiently avoid possible occurrence of nonconforming products.

Also, the sampling data signal for creating the sampling waveform is generated by calculating the electric signal transferred from the pressure sensor 12 in the embodiment, however, the sampling waveform may be preliminary stored in a storage unit of the determination unit 11.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A waveform monitoring apparatus, comprising:
a hydraulic cylinder, incorporated in an injection molding device for ejecting a molding material;
a sensor, generating pressure data of the hydraulic cylinder;
a determinant, forming a measured value waveform based on the pressure data, and determining that whether the pressure data exceeds a reference pressure waveform by a predetermined range; and
a marking applier, applying a marking to an excess portion of the measured value waveform determined by the determinant.

2. The waveform monitoring apparatus as set forth in claim 1, further comprising a display which displays the measured value waveform having the excess portion to which the marking is applied.

3. The waveform monitoring apparatus as set forth in claim 1, further comprising a sorter which sorts a product formed from the molding material,
wherein the determinant outputs a determination signal indicating whether the pressure data exceeds the reference pressure waveform by the predetermined range to the sorter.

4. The waveform monitoring apparatus as set forth in claim 1, wherein the determinant stops an injecting operation of the injection molding device when the measured value waveform in which the pressure data exceeds a reference pressure waveform by a predetermined range is continuously detected more than a predetermined times.

5. The waveform monitoring apparatus as set forth in claim 1, wherein the determinant sets a upper limit range and a lower limit range with respect to the reference pressure waveform as the predetermined range.

6. The waveform monitoring apparatus as set forth in claim 1, further comprising a storage which stores the measured value waveform to which the marking is applied.

7. A method for monitoring a waveform, comprising the steps of:
generating pressure data of a hydraulic cylinder incorporated in an injection molding device for ejecting a molding material;
forming a measured value waveform based on the pressure data;
determining that whether the pressure data exceeds a reference pressure waveform by a predetermined range; and
applying a marking to an excess portion of the measured value waveform determined in the determinant step.

8. The method as set forth in claim 7, further comprising the step of displaying the measured value waveform having the excess portion to which the marking is applied.

9. The method as set forth in claim 7, further comprising the step of outputting a determination signal to a sorter which sorts a product formed from the molding material,
wherein the determination signal indicates that whether the pressure data exceeds the reference pressure waveform by the predetermined range.

10. The method as set forth in claim 7, further comprising the step of stopping an injecting operation of the injection molding device when the measured value waveform in which the pressure data exceeds a reference pressure waveform by a predetermined range is continuously detected more than a predetermined times.

11. The method as set forth in claim 7, wherein the predetermined range is set a upper range and a lower range with respect to the reference pressure waveform.

12. The method as set forth in claim 1, further comprising the step of storing the measured value waveform to which the marking is applied.
